(19) United States
(12) Patent Application Publication
(10) Pub. No.: US 2019/0277747 A1
(43) Pub. Date: Sep. 12, 2019

(54) Optically Heated and Optically Measured Fouling Sensor

(71) Applicants: Christopher Michael Bjustrom Holt, Edmonton (CA); Fabien Souris, Grenoble (FR); John Patrick Davis, Edmonton (CA); Vincent Theo Karel Sauer, Edmonton (CA); Julian Haagsma, Edmonton (CA)

(72) Inventors: Christopher Michael Bjustrom Holt, Edmonton (CA); Fabien Souris, Grenoble (FR); John Patrick Davis, Edmonton (CA); Vincent Theo Karel Sauer, Edmonton (CA); Julian Haagsma, Edmonton (CA)

(21) Appl. No.: 16/195,968

(22) Filed: Nov. 20, 2018

Related U.S. Application Data
(60) Provisional application No. 62/588,527, filed on Nov. 20, 2017.

(51) Int. Cl. G01N 17/00

(52) U.S. Cl. CPC G01N 17/008

(57) ABSTRACT

An optical fouling sensor includes optical heating and optical temperature measurement of a sensor. The optical signals can interact with the sensor either through optical fibers or free space optical signals or any combination of the two. Using a heat transfer equation allows determination of the amount of fouling on a sensor, from the optical measurements.

### BACKGROUND

### Field of the Invention

The invention is a system and method for conducting a fouling test in an operating process plant or in a laboratory environment using optical methods.

### Background of the Related Art

Fouling refers to the accumulation of material on the surface of an apparatus, interfering with proper operation of the apparatus. The material deposited on the surface, known as foulant, may be organic, inorganic, biological, or a combination thereof.

Fouling is typically associated with process fluids in systems where there is a temperature differential at the surface of the system. In systems where the process fluids are oil based and are being heated, fouling is typically associated with a breakdown of some of the process fluid at the heated surface, into such elements as coke, polymers, salts and other inorganics. The accumulation of material on such a surface has several undesirable effects: heat transfer is reduced, as foulant has a lower heat transfer coefficient, and thus acts as an insulator, decreasing system efficiency; the accumulated material can impede flow, reducing system efficiency; and, when efficiency has degraded beyond acceptable limits, a cleaning of the system must be performed, typically involving costly shutdowns. Fouling can be controlled by adding anti-fouling chemicals, changing the properties or mixture of the fluid being processed or by adjusting process conditions to reduce fouling propensity. To adjust and optimise each of these fouling control mechanisms, an accurate method of measuring the fouling rate is required, either in the laboratory or online in the process system. Improvements in the accuracy, sensitivity, and repeatability of this fouling rate measurement can result in significant improvements in the fouling control measures undertaken by an operator.

Quantifying and measuring a “fouling factor” aids in the decision process as to how to deal with fouling, and allows for comparisons between fluids, fluid mixtures, additives and conditions.

Fouling of a surface as described above is subject to many variables, including temperature of the fluid and surface, system pressure, system gas composition, fluid composition, fluid flow type and fluid velocity. In order to make comparisons of a measured fouling factor useful, tests are conducted in environments where these variables can be isolated and kept constant. Pressure is held constant, as is fluid velocity. Tests may be run isolating either fluid composition and changing temperatures, or isolating temperature and changing fluid compositions. By holding these variables constant, a fouling factor can be determined which is useful for comparing the fouling characteristics of various fluids and conditions.

### Background Theory

The decreased heat transfer caused by fouling can be used as an in-situ measurement of the amount of fouling. This reduction in heat transfer from foulant buildup may be expressed as a fouling factor, a measure of the net insulative factor of deposited foulant.

The heat transfer coefficient of a material, h, is defined as:

$$h = \frac{q}{Δ T}$$

where q is the amount of heat transferred, or heat flux, measured in W/m², and ΔT is the temperature difference across the material. The heat transferred can be further broken down into the total thermal power produced, Q, divided by the area, A over which it is produced:

$$q = \frac{Q}{A}$$

The total heat transfer coefficient, U, of a simple (equal areas) conduction-only system with multiple heat transfer coefficients, h, in series can be described using the method below:

$$\frac{1}{{U}_{series}} = \frac{1}{{h}_{1}} + \frac{1}{{h}_{2}} + …$$

This combines the heat transfer coefficients of different elements of the system into an overall heat transfer coefficient. Similarly, the total heat transfer coefficient of a simple conduction-only system with multiple heat transfer coefficients in parallel can be described using the following method:

U_{paralled}=h₁+h₂+ . . .

Since foulant occurs on a surface where there is a temperature differential and sits between a fluid and solid surface, the foulant is thermally in series between the fluid and the solid surface.

If one considers the overall heat transfer coefficient of a system before fouling, U_{clean}:

$$\frac{1}{{U}_{clean}} = \frac{1}{{h}_{1}} + \frac{1}{{h}_{2}} + …$$

then when foulant accumulates on the surface of the system, there will be an additional heat transfer coefficient for the foulant, h_{f}, which must be added:

$$\frac{1}{{U}_{fouled}} = \frac{1}{{h}_{f}} + \frac{1}{{h}_{1}} + \frac{1}{{h}_{2}} + …$$

The difference between the system before and after fouling may thus be related as:

$$\frac{1}{{h}_{f}} = \frac{1}{{U}_{fouled}} - \frac{1}{{U}_{clean}}$$

The reciprocal of the heat transfer coefficient is traditionally defined as the “fouling factor”, R_{f}:

$${R}_{f} = \frac{1}{{h}_{f}}$$

Combining this with the previous result, we can find the fouling factor from:

$${R}_{f} = \frac{1}{{U}_{fouled}} - \frac{1}{{U}_{clean}}$$

Since U is an overall heat transfer coefficient, and a heat transfer coefficient is defined as the amount of heat transferred over the temperature difference, it may be described similarly to h in the first equation:

$$U = h = \frac{q}{Δ T}$$

Using this and the fact that heat transferred may be described as the thermal power times the area, R_{f} may be expanded; q may further be expanded for an apparatus where the heat transfer area is known:

$${R}_{f} = \frac{Δ {T}_{f}}{{q}_{f}} - \frac{Δ {T}_{c}}{{q}_{c}} = \frac{Δ {T}_{f} A}{{Q}_{f}} - \frac{Δ {T}_{c} A}{{Q}_{c}}$$

By measuring the temperature difference between the interior of the system and the fluid which is acting as a thermal sink, and measuring the power used, for both fouled and clean conditions, the fouling factor may be determined.

Since fouling characteristics of a given fluid tend to vary significantly with temperature, a fouling factor is best measured at a constant temperature. As the foulant accumulates on a testing apparatus, the fouling factor increases, and the thermal power required to maintain a constant ΔT will decrease. Thus, by controlling input power to hold ΔT constant, a fouling factor may be monitored.

### EXAMPLE 1

A hot wire with a diameter of 1 mm and a length of 1 cm has been maintained at a temperature of 250° C. in a fluid of 200° C., by varying the current. The current has dropped from 1.0 A to 0.707 A and the voltage has dropped from 1.2V to 0.848V over 6 hours.

ΔT=250 C-200 C=50K

A=π(1 mm)(1 cm)=3.141*10⁻⁵ m²

Q_{c}=VA=(1.2V)(1.0 A)=1.2 W

Q_{f}=VA=(0.848V)(0.707 A)=0.6 W

R_{f}=50K*3.141*10⁻⁵ m²/0.6 W−50K*3.141*10⁻⁵ m²/1.2 W=0.00130875 Km²/W

The fouling factor is 0.0013 Km²/W after 6 hours.

### EXAMPLE 2

A silicon cylinder is kept at 300° C. with a pulsing laser, in a fluid at 250° C. The cylinder is 0.2 mm in diameter and 1 mm high, and only one face and the sides are exposed. Over 6 hours, the average power (delivered to the cylinder) the pulsed laser has used to keep the cylinder hot drops from 0.50 W to 0.25 W.

ΔT=300 C−250 C=50K

A=π(0.1 mm)²+π(0.2 mm)(1 mm)=6.597*10⁻⁷ m²

Q_{c}=0.50 W

Q_{f}=0.25 W

R_{f}=50K*6.597*10⁻⁷ m²/0.25 W−50K*6.597*10⁻⁷ m²/0.50 W=6.597*10⁻⁵ Km²/W

The fouling factor is 6.597*10⁻⁵ Km²/W after 6 hours.

### Background Theory: Calibration

In order to make an accurate calculation of the fouling factor, an accurate temperature difference between the fluid and the fouling surface must be known. To measure the temperature of the fluid, a simple thermocouple, resistance temperature detectors, or other methods may be used. To measure the temperature of the fouling surface, without seriously affecting heat transport, the surface must be characterized and calibrated via an external method in order to determine a relationship between the temperature and some proxy variable (i.e. electrical resistance, mechanical length, infrared emission, thermocouple voltage).

In the case of an electrical wire, the resistance is typically mapped to temperature by placing the wire in a non-fouling fluid or other medium, and slowly heating this medium through the desired temperature range, while monitoring the resistance of the electrical wire. It can alternately be mapped to temperature by heating the wire as in an actual test, in air, nitrogen, or argon, and monitoring the infrared signature of the wire with a thermal camera.

In the case of an optically heated device a similar method may be used; the optical device is placed in a non-fouling fluid or medium, which is slowly heated through the desired temperature range, while the optical device is monitored, to create a mapping between temperature and the optical response. Similarly, a thermal camera may be used to determine the temperature while the plug is being slowly heated through the desired temperature range while monitoring the optical response, to accurately map the optical response to the temperature. The optical response could be one of a number of mechanisms including, but not limited to: a fluorescent decay rate where the decay in fluorescence from an optical light pulse changes with temperature; a fluorescent intensity measurement; an intensity spectrum of light in the visible or near infrared range; or an intensity spectrum that shifts due to the spacing of two reflectors in a Fabry-Perot interferometer.

### BRIEF SUMMARY

Fouling probes can rely on electrical signals using heated metallic wires within the fluid under test. In some cases it is not desirable to operate under these conditions due to the risk of sparking within an inflammable fluid; electrical contacts can lead to added error, as can electrical contact with the fluid before the main sensor; there may be corrosion issues with metallic wires, especially with electrical contact; furthermore, as electrical wires get longer, additional error is observed. To circumvent these issues, the invention uses optical signals to perform the fouling measurement, by independently heating and measuring the temperature of the fouling probe.

One embodiment of the present invention provides an optical fouling test probe which utilizes temperature sensitive fluorescent materials. This includes, but is not limited to, measuring the fluorescent decay of the material to determine temperature, and/or measuring the intensity of the fluorescent response of the material to determine the temperature.

Another embodiment of the present invention utilizes one or more optical cavity structures to measure the temperature of the fouling probe. These can include, but are not limited to, Fabry-Perot cavities, racetrack or ring resonator cavities, or photonic crystal cavities. They may be utilized in an interferometric-type setup.

Another embodiment of the present invention uses the volume change of a piece of silicon to measure the temperature of the fouling probe. The volume, and therefore the length, of the silicon pillar will expand and contract as its temperature varies, due to its coefficient of thermal expansion. The result is that the optical resonances—which can be easily measured remotely through the optical fiber—are a readout of the temperature of the miniature silicon pillar. This, coupled with the fact that a secondary visible wavelength of light can be used to heat the pillar forms the technology basis for our proposed thermal fouling sensor. If we use the visible light to heat the pillar, and monitor the optical resonances, we can feedback on this signal to monitor and keep the pillar at a fixed temperature above its surrounding media. If foulant accumulates on the pillar, this will change the thermal conductance from the pillar to its surrounding, and therefore the intensity of visible wavelength light needed to maintain its temperature.

Another embodiment of the present invention utilizes optical laser sources to heat the fouling probe. This heating can be implemented either through a free-space optical system or an integrated fiber system.

### BRIEF DESCRIPTION OF THE DRAWINGS

FIG. 1 is a diagram of an optical fouling probe setup.

FIG. 2A-2C are examples of methods of bringing the optical signals to the fouling sensor using possible optical fiber implementations.

FIG. 3 is a diagram of the method of using a free space optical signal to address the fouling sensor through a transparent optical window.

FIG. 4 is a diagram of the combined method of fiber optic and free space addressing of the fouling sensor.

FIG. 5 illustrates an example of implementing the optical fiber sensor in conjunction with secondary sensors in the same process chamber.

FIG. 6 is a diagram of a Fabry-Pérot type optical fouling sensor.

FIG. 7 is a diagram of a ring resonator type optical fouling sensor.

FIG. 8 is a diagram of a Fabry-Pérot type optical fouling sensor which is operating with the accumulation of foulant on the sensor.

FIG. 9 is a diagram representing a possible measured signal from an interferometric type optical fouling sensor.

FIG. 10 is a diagram representing a possible measured signal from an optical cavity type optical fouling sensor

FIG. 11 is a system diagram representing a possible system for measuring the optical fiber based fouling probe

FIG. 12 is a graph of a calibration of reflected amplitude for the temperature measurement while the temperature is changed during a calibration procedure.

FIG. 13A-B: Images adapted from (G. Liu and M. Han, “Fiber-optic gas pressure sensing with a laser-heated silicon-based Fabry-Perot interferometer,” Optics letters, vol. 40, no. 11, pp. 2461-2464, 2015.), showing the central premise of the silicon pillar optical resonator.

FIG. 14: Sketch of a Fabry-Perot cavity with two different reflectivities.

FIG. 15A-B: Expected reflection/transmission spectrum for a 280 μm silicon tip b) is a magnified version of a).

FIG. 16: Expected reflection/transmission spectrum for a 2 μm silicon tip.

FIG. 17A-C: (a) Setup used to glue the silicon tip onto the optical fiber. (b) the silicon wafer diced into 0.5×0.5 mm chips. (c) The silicon chip glued onto the optical fiber.

FIG. 18: (left) Experimental setup used to attach the silicon chip with molten Glass. (right) The silicon chip attached to the fiber with melted glass.

FIG. 19: Optical setup used to measure the reflection of the silicon cavity.

FIG. 20A-B: Reflection spectrum measured with the 280 μm silicon pillar. The black curve is the photodiode signal, normalized to take into account the wavelength dependent laser intensity and propagation through different optical element. The grey curve is a fit “by eye” using the value L=259.64 μm. Each local minimum is roughly located using a peak-finding function (black circle) and then fit using the second order polynomial in order to extract a more accurate value of the local minimum (orange circle). b) is a magnified version of a)

FIG. 21: Location of the 20th to 30th local minima as a function of incident heating power. The linear increase in the minimum wavelength is due to the temperature change of the silicon pillar changing its length and refractive index

FIG. 22: Reflected intensity as a function of temperature. The gray points correspond to measured data. The black curve is a theoretical model according to equation 27. To fit the theoretical model to the data the value of λ¹0^{d}d^{λ}T⁰had to be changed to 86 pm/° C.

FIG. 23: Reflected intensity as the heating laser power is increased. The initial oscillations at the beginning of the recording correspond to the increase in the laser power, heating up the tip. The oscillations near the end of the recording correspond to the decrease of the heating laser power.

### DETAILED DESCRIPTION

One embodiment of the present invention provides a fouling test probe utilizing independent optical signals to both measure the temperature of the sensor and control the temperature of the sensor. The temperature of the sensor is determined by detecting optical power signals using an optical detector such as a photodiode or a spectrometer, and these optical power signals are sent to the system controller.

The optical signals may be transmitted from the fouling sensor in various ways. One such way is a direct connection using one or more fiber optic cables. The fiber cables transmit the temperature signal as well as the optical signal used to heat the sensor, to or from the fiber sensor. Another way is to shine the optical signals through free-space and an optically transparent window to transmit to the fouling sensor. This method may utilize focusing lenses to direct the light to the sensor and collect the light from the sensor, in the case of the optical temperature measurement, or to focus the light on the sensor as is the case of the optical signal used for heating. The system may also be implemented using a combination of both techniques.

The method may include the input and output of optical signals to one or more fouling probes either simultaneously, or sequentially. Accordingly, an amount of foulant accumulation on one or more probes may be determined as a function of multiple process variables including, but not limited to probe temperature, process fluid temperature, and location.

The optical temperature probe may take various forms. One such form may utilize an optical cavity to determine the sensor temperature. Optionally, a broad spectrum light source may be sent to the optical cavity. At the interface to the optical cavity, light is partially reflected and partially transmitted into the optical cavity. Light will travel through the optical cavity, and is output in such a way that it will optically interfere with the light that had initially been partially reflected. The temperature of the optical cavity will create a very specific optical interference response which will be expressed as a function of optical output versus wavelength. This response may be measured using an optical spectrometer. In another option, a single wavelength light source is sent to the optical cavity and is partially reflected and partially transmitted into the optical cavity as described above such that an optical interference response signal is created. The response may be measured using a single photodiode which may measure the optical power of this interference signal. The wavelength of the light source may then be swept across a set range to create an optical output versus wavelength graph. This response curve will be a function of the optical cavity temperature.

The optical cavity may further take various forms. One such form may be a Fabry-Pérot type optical cavity. One example of a Fabry-Pérot cavity may be a thin slab of silicon placed in the path of the travelling light signal. The light will reflect off of the incident surface of the silicon slab, and then off of the inner surface of the silicon slab to interfere at the incident surface boundary. Another example of a Fabry-Pérot cavity may include using a piece of optical fiber with integrated mirrors such as, but not limited to, Bragg reflectors. In this case the fiber itself will embody the Fabry-Pérot cavity. Another form may include a ring resonator optical cavity. In this example the ring resonator would only allow light of a specific wavelength to pass through the cavity. The wavelength of light allowed is dependent on the temperature of the sensor, so as above the output of the cavity is dependent on the temperature of the sensor. Another form may include a racetrack resonator optical cavity. In this example the racetrack resonator operates in a similar manner to the ring resonator cavity. Another form may include a photonic crystal optical cavity. In this example the photonic crystal cavity only allows light of a specific wavelength to pass through it. This wavelength is dependent on the temperature of the sensor.

The optical temperature sensor may take the form of an interferometric device. In such a device the light signal is split along two different optical paths. One path is a reference path and is not affected by the temperature of the sensor, while the second path is the measurement path which is affected by the temperature of the sensor. When the two paths recombine they will interfere and the resultant signal will be a function of the wavelength of light used and the temperature of the sensor. The interferometric device may further take the form of either a common path interferometer, or else a double path interferometer.

Another form of the optical temperature probe is a fluorescent material that is sensitive to temperature. Optionally, the optical signal sent to the fluorescent material would cause a fluorescing signal of an intensity magnitude which is measured and is dependent on the temperature. In a separate option, the optical signal sent to the fluorescent material would cause a fluorescing signal which has a rate of decay which is measured and is dependent on the temperature.

To heat the fouling sensor, a wavelength of light between 150 nm and 1100 nm is used and input to the fouling sensor. Light at these wavelengths is partially adsorbed in the sensor in the form of heat. The higher the intensity of the laser at a constant wavelength, the more heat will be input into the sensor. The wavelength of light chosen will also affect the amount of heat and is chosen based on physical sensor properties.

The wavelength of the optical signal used to detect the temperature of the fouling sensor will be in the range of 400 nm to 1700 nm.

The system may include a chamber or autoclave in which the test fluid is contained. In an example, the test probe is placed into the autoclave and is comprised of a thin silicon slab which is attached to one end of a fiber-optic cable, which may be contained within cladding or protective or structural materials. Feedthroughs may be used to place the probe in contact with the test fluid.

Embodiments of the present invention allow optical monitoring of fouling in operating refineries, petrochemical plants, and other facilities that have hydrocarbon containing process fluids. For example, the optical fouling test probe may be used to perform real-time measurement of total fouling buildup or a rate of fouling deposition.

Other embodiments of the present invention allow optical monitoring of fouling in cooling towers, water treatment facilities, and other facilities that have circulating water processes. For example, the optical fouling test probe may be used to perform real-time measurement of scaling buildup or rate of fouling deposition.

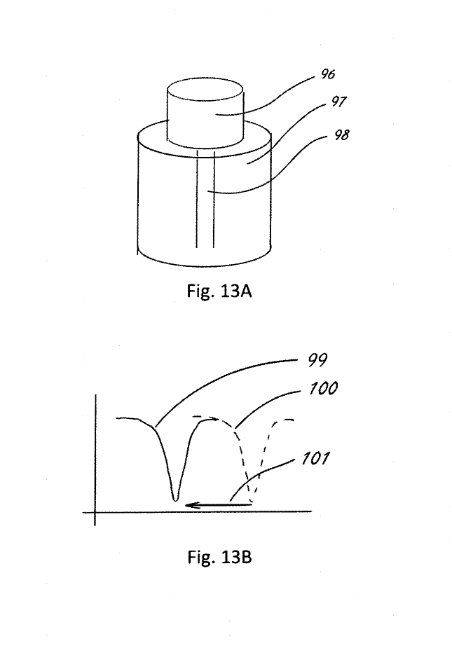

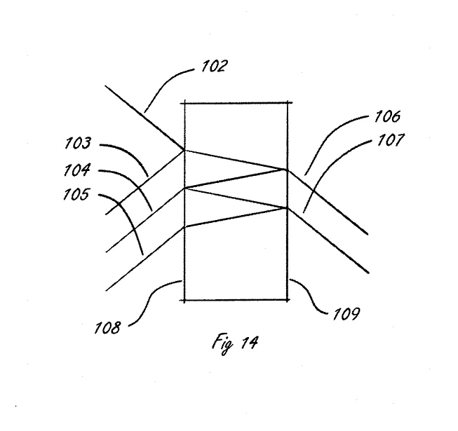

One embodiment of the present invention will be outlined in detail below. The initial premise for this embodiment of the fiber-optic sensor comes from a recent paper describing a fiber-optic gas pressure sensor by Liu et al. [3], shown in FIG. 13. In this work, the authors have affixed a microfabricated silicon pillar onto the end of an optical fiber. The key feature is that silicon is opaque at visible wavelengths yet is transparent at telecom wavelengths, such as the 1550 nm band frequently used in an optical sensor laboratory, while the optical fiber is transparent to both visible and telecom wavelengths.

When telecom-wavelength light is sent down the glass optical fiber, a small part of the intensity is reflected when it reaches the silicon/glass interface. The rest of the light enters the silicon pillar and bounces back and forth between the two faces of the silicon pillar, forming a so-called optical resonator cavity. This is analogous to the optical cavity inside a laser that make them so powerful. If one monitors the amount of light reflected back from the optical resonator, one finds a series of dips in the reflected intensity as a function of wavelength that correspond to those wavelengths where light can form a standing wave inside the silicon pillar. These optical resonances, analogous to the mechanical resonances of a vibrating guitar string, are extremely sensitive to the dimensions of the silicon pillar, specifically its length, and therefore provide a precision measurement of the state of the silicon pillar.

A detailed description of the operation of a Fabry-Perot resonator will be described to better understand this method of temperature measurement for a fouling sensor.

The silicon tip of the fiber forms a Fabry-Perot resonator with a glass to silicon interface and a′ silicon to air interface, each having a different reflection coefficient. In this section we detail the theoretical treatment of a Fabry-Perot cavity with two different reflection coefficients. FIG. 14 is a sketch of such a cavity where each reflection is represented and labeled by its amplitude.

E₀ is the incident amplitude.

r (r′) is the reflection coefficient of a beam entering (leaving) the silicon.

t (t′) is the transmission coefficient of a beam entering (leaving) the silicon.

δ is the phase accumulated after a round-trip through the silicon cavity.

The transmitted amplitude is calculated by taking the sum of every beam amplitude leaving the cavity (a phase shift of e^{jδ/2} common to every transmitted beam has been removed for simplicity), which are:

$$\begin{matrix}{E}_{{t}_{1}} = {E}_{0} {t}_{1} {t}_{2}^{′} \\ {E}_{{t}_{2}} = {E}_{0} {t}_{1} {r}_{2}^{′} {r}_{1}^{′} {t}_{2}^{′} {e}^{i δ} \\ {E}_{{t}_{3}} = {E}_{0} {{t}_{1} ( {r}_{2}^{′} {r}_{1}^{′} )}^{2} {t}_{2}^{′} {e}^{i 2 δ} \\ ⋮ \\ {E}_{{t}_{N}} = {E}_{0} {{t}_{1} ( {r}_{2}^{′} {r}_{1}^{′} )}^{( N - 1 )} {t}_{2}^{′} {e}^{i ( N - 1 ) δ}\end{matrix}$$

The sum Eₜ of all those terms is therefore:

$${E}_{t} = {E}_{{t}_{1}} + {E}_{{t}_{2}} + {E}_{{t}_{3}} + … + {E}_{tN} = {E}_{0} {t}_{1} {t}_{2}^{′} [ 1 + {r}_{2}^{′} {r}_{1}^{′} {e}^{i δ} + {( {r}_{2}^{′} {r}_{1}^{′} )}^{2} {t}_{2}^{′} {e}^{i 2 δ} + … + {( {r}_{2}^{′} {r}_{1}^{′} )}^{( N - 1 )} {t}_{2}^{′} {e}^{i ( N - 1 )} ]$$

If |r′₂r′₁e^{iδ}|<1 and when N→∞ then Eₜ can be rewritten:

$${E}_{t} = {E}_{0} \frac{{t}_{1} {t}_{2}^{′}}{1 - {r}_{2}^{′} {r}_{1}^{′} {e}^{i δ}}$$

The light intensity is:

$${I}_{t} = {E}_{t} {\overline{E}}_{t} = {E}_{0}^{2} \frac{{t}_{1}^{2} {t}_{2}^{′2}}{( 1 - {r}_{2}^{′} {r}_{1}^{′} {e}^{i δ} ) ( 1 - {r}_{2}^{′} {r}_{1}^{′} {e}^{- i δ} )} = {E}_{0}^{2} \frac{{t}_{1}^{2} {t}_{2}^{′2}}{{( 1 - {r}_{1} {r}_{2} )}^{2} + 4 {r}_{1} {r}_{2} {sin}^{2} δ / 2}$$

The same treatment can be applied to the reflected amplitude with the reflected beams amplitude being:

$$\begin{matrix}{E}_{{r}_{1}} = {E}_{0} {r}_{1} \\ {E}_{{r}_{2}} = {E}_{0} {t}_{1} {r}_{2}^{′} {t}_{1}^{′} {e}^{i δ} \\ {E}_{{r}_{3}} = {E}_{0} {t}_{1} {r}_{2}^{′2} {r}_{1}^{′} {t}_{1}^{′} {e}^{i 2 δ} \\ ⋮ \\ {E}_{{r}_{N}} = {E}_{0} {t}_{1} {r}_{2}^{′} {r}_{2}^{′ ( N - 2 )} {r}_{1}^{′ ( N - 2 )} {t}_{1}^{′} {e}^{i δ } {e}^{i ( N - 2 ) δ}\end{matrix}$$

The sum Eᵣ of all those terms is:

$${E}_{r} = {E}_{{r}_{1}} + {E}_{{r}_{2}} + {E}_{{r}_{3}} + … + {E}_{{r}_{N}} = {E}_{0} [ {r}_{1} + {t}_{1} {r}_{2}^{′} {t}_{1}^{′} {e}^{i δ} ( 1 + … + {r}_{2}^{′ ( N - 2 )} {r}_{1}^{′ ( N - 2 )} {e}^{i ( N - 2 ) δ} ) ]$$

If |r′₂r′₁e^{iδ}<1 and when N→∞ then Eᵣ can be rewritten:

$${E}_{r} = {E}_{0} [ {r}_{1} + \frac{{t}_{1} {r}_{2}^{′} {t}_{1}^{′} {e}^{i δ}}{1 - {r}_{2}^{′} {r}_{1}^{′} {e}^{i δ}} ]$$

After some algebra and using the relations t₁t′₁=1=r₁² and rᵢ=−r′ᵢ, it can be rewritten:

$${E}_{r} = {E}_{0} [ \frac{{r}_{1} - {r}_{2} {e}^{i δ}}{1 - {r}_{2} {r}_{1} {e}^{i δ}} ]$$

The reflected amplitude is equal to:

$${I}_{r} = {E}_{r} \overline{{E}_{r}} = {E}_{0}^{2} \frac{( {r}_{1} - {r}_{2} {e}^{i δ} ) ( {r}_{1} - {r}_{2} {e}^{- i δ} )}{( 1 - {r}_{2} {r}_{1} {e}^{i δ} ) ( 1 - {r}_{2} {r}_{1} {e}^{- i δ} )}$$

Giving

$${I}_{r} = {E}_{0}^{2} \frac{{r}_{1}^{2} + {r}_{2}^{2} - 2 {r}_{1} {r}_{2} cos δ}{{( 1 - {r}_{1} {r}_{2} )}^{2} + 4 {r}_{1} {r}_{2} {sin}^{2} δ / 2} \qquad$$

In order to express Iₜ in terms of r₁and r₂, we need to use energy conservation arguments. Since the total intensity is conserved, we have:

I₀=Iₜ+Iᵣ

That leads to the following relation between the reflection/transmission coefficients:

t₁²t′₂²=(1−r₁²)(1−r₂²).

According to this equation the transmitted intensity can be rewritten:

$${I}_{t} = \frac{( 1 - {r}_{1}^{2} ) ( 1 - {r}_{2}^{2} )}{{( 1 - {r}_{1} {r}_{2} )}^{2} + 4 {r}_{1} {r}_{2} {sin}^{2} δ / 2} \qquad$$

Free spectral range and location of the reflection minimum

For a large number of interference fringes, the state of the silicon resonator is monitored by tracking the intensity minima. We quickly derive here the frequencies v₀ (or alternatively the wavelengths λ₀) at which those intensity minima are found.

Obviously, the reflection minima occur when the transmission is at its maximum, i.e. when sin²(δ/2)=0, this leads to:

$$\frac{δ}{2} = m π$$

With δ=nk2L, Where L is the length of the silicon (so 2 L for a round trip), k the light wavenumber, n the refractive index of the silicon and m is an integer number. The minima are then located at:

$${λ}_{0} = \frac{n 2 L}{m} or {v}_{0} = \frac{cm}{n 2 L} , \qquad$$

With c being the speed of light. The free spectral range (FSR) is the spacing between two successive minima, i.e.:

$$Δ {v}_{0} = \frac{c}{n 2 L}$$

Expressed in terms of wavelength and for m>>1, it is:

$${Δλ}_{0} = \frac{- {λ}_{0}^{2}}{n 2 L}$$

Computed Reflection Spectra

For these few examples we will consider the incident light normal to the silicon slab. In this case we have:

$${r}_{1} = \frac{{n}_{glass} - {n}_{Si}}{{n}_{glass} + {n}_{Si}}$$

$${r}_{2} = \frac{{n}_{air} - {n}_{Si}}{{n}_{air} - {n}_{Si}}$$

With nₐᵢᵣ=1, n_{Si}=3.47 and n_{glass}=1.32, we obtain r₁=0.45 and r₂=0.55.

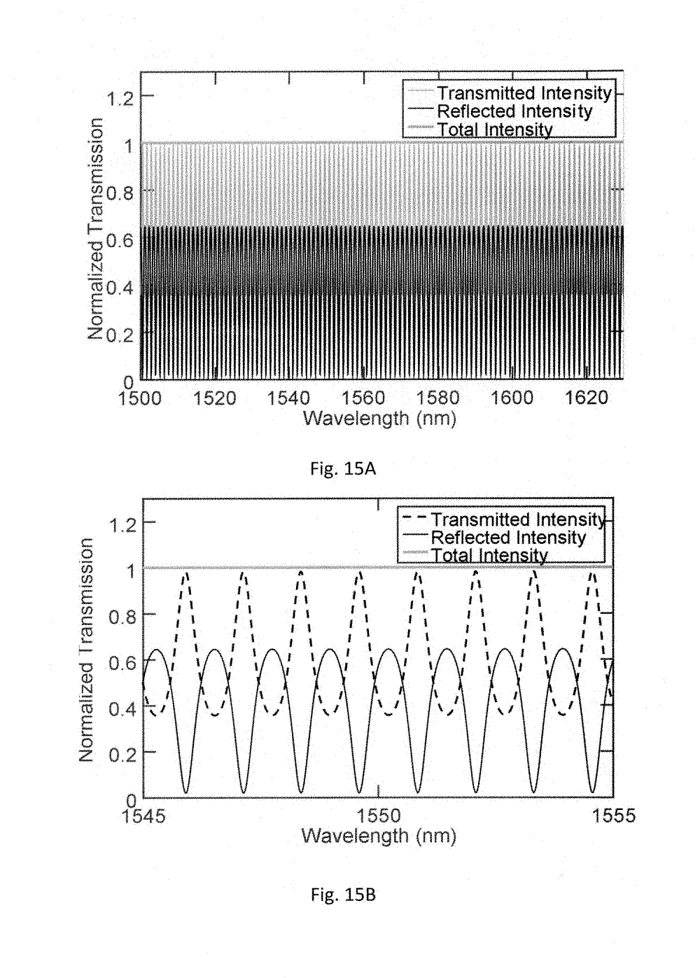

FIG. 15 represents the reflection spectrum expected for a 280 μm silicon pillar. In this case the FSR is equal to Δλ₀=1.23 μm. Consequently in the range 1500-1630 μm, a large number of 105 interference fringes can be observed. Because of the small values of r_{1,2}, the resonance peaks have a value comparable with the FSR.

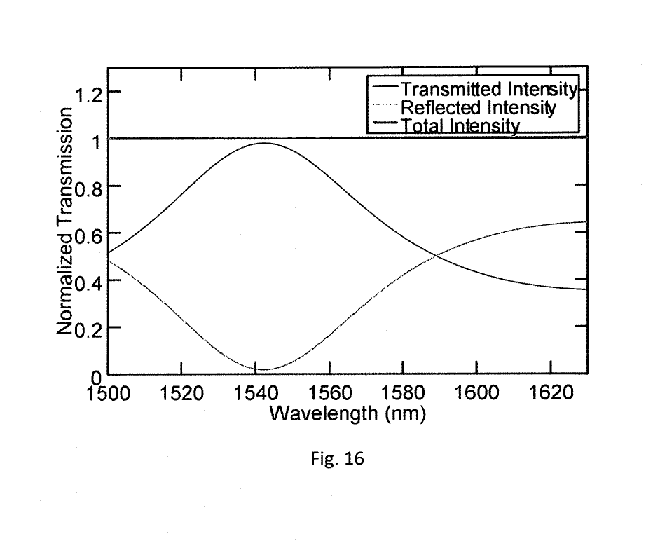

If the thickness of silicon at the tip of the fiber is reduced to a value comparable to the optical wavelength, the spectrum has a drastically different aspect as shown in FIG. 16. For a 2 μm tip the value of the FSR is about 173 μm and in the range 1500-1630 μm only one minimum of the reflection can be observed. The absolute minimum thickness of silicon in order to be able to observe a minimum above 1500 μm is equal to 0.16 μm

The reflected intensity given in Eq. 10 depends on several parameters: r₁ the reflection coefficient on interface 1, r₂ the reflection coefficient on interface 2, n the refractive index of the silicon, k the wavenumber of the incident light and L the length of the cavity. Over all these parameters, only n(7) and L(T) have a temperature dependence. The refractive index n(T) dependence on temperature is characterized to the first order by the thermo-optic coefficient:

$$\frac{1}{n} \frac{\partial n}{\partial T} ≃ 1.5 \times {10}^{- 4} ∼ {K}^{- 1}$$

And the length L depends on temperature through the thermal expansion coefficient:

$$\frac{1}{L} \frac{\partial L}{\partial T} ≃ 2.55 \times {10}^{- 6} ∼ {K}^{- 1}$$

In reference Liu 2015 they give an experimental value of

$$\frac{1}{{λ}_{0}} \frac{d {λ}_{0}}{dT} = 86 pm / ° C .$$

It is interesting to notice that the thermo-optic coefficient is much larger than the thermal expansion coefficient. The change in the the reflection minimum dλ₀ with respect to a change in temperature dT is then given by:

$$\begin{matrix}\frac{d {λ}_{0}}{dT} = \frac{\partial {λ}_{0}}{\partial n} \frac{dn}{dT} + \frac{\partial {λ}_{0}}{\partial L} \frac{d L}{dT} \\ = \frac{{λ}_{0}}{n} \frac{dn}{dT} + \frac{{λ}_{0}}{L} \frac{d L}{dT} \\ = {λ}_{0} ( \frac{1}{n} \frac{dn}{dT} + \frac{1}{L} \frac{d L}{dT} )\end{matrix}$$

In order to add the temperature dependence to the reflected intensity, it is possible to rewrite Eq. [0085] with a parameter δ(T) depending on temperature. In a similar way to how we obtain Eq. [0103] we can write this parameter:

$$δ ( T ) = δ {\vert}_{{T}_{0}} + \frac{d δ}{dT} {\vert}_{{T}_{0}} dT = δ {\vert}_{{T}_{0}} ( 1 + ( \frac{1}{n} \frac{dn}{dT} + \frac{1}{L} \frac{d L}{dT} ) dT )$$

The temperature dependent reflected intensity is therefore:

$${I}_{r} = {E}_{0}^{2} \frac{{r}_{1}^{2} + {r}_{2}^{2} - 2 {r}_{1} {r}_{2} cos ( δ ( T ) )}{{( 1 - {r}_{1} {r}_{2} )}^{2} + 4 {r}_{1} {r}_{2} {sin}^{2} ( δ ( T ) / 2 )}$$

Multiple methods are possible to assemble an all optical fouling sensor described in this work. These methods will be outlined below to provide a better understanding of what is required to make an optical fouling sensor. The first method described involves using glue to attach a Fabry-Perot silicon cavity to the end of an optical fiber.

As a first attempt to observe Fabry-Perot resonance in a silicon micropillar involved gluing a piece of diced silicon wafer at the end of a freshly cleaved optical fiber.

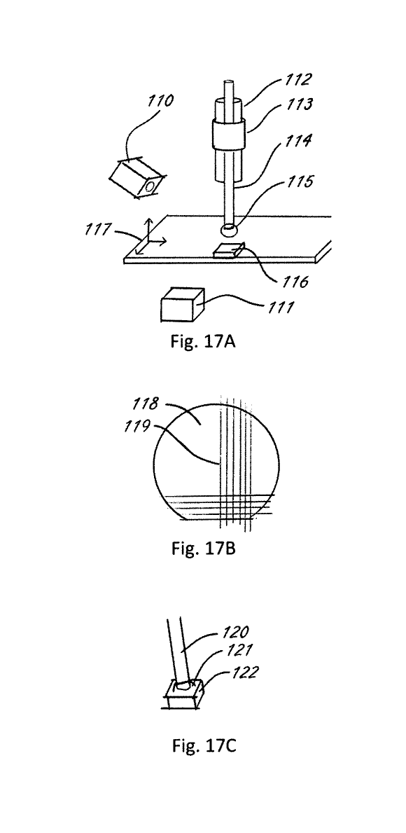

The silicon wafer, provided by University Wafer, is double sided polished, has a thickness of 280 μm and has a <100> orientation. It was diced on a Disco Dad 321 dicing machine in a cleanroom facility in 0.5×0.5 mm squares and left on the sticky blue dicing tape, as shown in FIG. 17. The wafer is shown at 118 and the dicing lines spaced 0.5 mm apart are shown at 119.

The optical fiber 114, is a stripped telecom patch cable (to avoid the need of splicing the fiber to a connector) cleaved at its end. The gluing procedure is represented on FIG. 17. The square silicon chip is placed on a 3-axis translation table 117 and monitored with two cameras (111 and 111) looking along two different axis of the chip. The fiber is taped 113 on a post 112 with the cleaved face down right above the silicon chip. A droplet of UV curable epoxy was deposited at the end of the fiber 115.

By moving the translation stage, the chip 116 is brought into contact with the fiber. As soon as the UV epoxy wets the silicon chip, capillary force immediately pulled the chip against the fiber providing an automatic alignment of the two faces ideally parallel to each other. If the result is satisfactory the epoxy is cured by flooding it with ultraviolet light. The final result is shown on FIG. 17 with the fiber 120 attached to the silicon block 122 by epoxy 121. It is possible to complete this procedure with a wide range of adhesive materials and not just UV epoxy. One of the key requirements of this epoxy is that it provides a strong bond to the silicon and that it is chemically and thermally resistant to the fluid that the fouling sensor will be operated in.

To produce a silicon tip that would be more resilient to large temperature changes and harsh chemical environments, one method to produce a sensor is to attach the silicon and fiber by melted glass. A glass frit that is typically used to seal or glaze metals, ceramics or natural quartz was used for this bonding. The advantage of such a glass is that it has a low melting point 400-440° C., which gives the possibility of melting the glass, far before the optical fiber deteriorates. The tip is first mounted onto the fiber using the protocol described above involving UV epoxy. Using a wooden stick with a V-shaped groove, the diluted glass frit is applied in several steps on top of the UV epoxy to create a thick layer. The assembly is then ready to be bonded together by melting the glass.

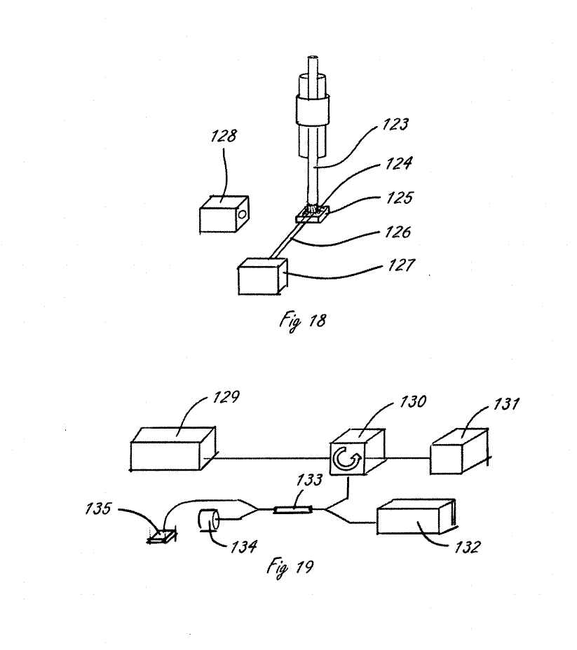

The silicon tip is very small and in order to have a localized heating, we focus a CO₂ laser 127 onto the tip using a ZnSe lens with a focal length 25.4 mm. The setup is shown on FIG. 18. The distance between the lens and the tip (we used 25.6 mm) is critical as the laser beam 126 quickly diverges reducing considerably the heating power. The process is monitored with a long distance microscope 128, installed at 33 mm from the tip. The laser power is slowly increased up to a maximum of 9% of maximum power while monitoring the process through the camera. The heating rate as to be slow (30 minutes to maximum power) to make sure that all the by-product of the process such as organic materials have enough time to escape to avoid creating intense bubbling that could misalign the silicon from the fiber. The cool down process is also done slowly to minimize thermal stresses around the tip that would make the device brittle. A number of glasses 124 could be used to adhere the silicon 125 to the glass fiber 123. Vitta glass tape was found to work well for this application. This method could also be used without a glass added and instead depend on the optical fiber glass softening to provide a direct bond to the silicon. It is also possible to conduct this type of bonding with an external furnace or heat source. Any process that provides heating of the silicon and glass fiber could be used to melt an adhesive glass or the glass of the optical fiber to make the silicon to fiber bond.

In order to form the optical cavity at the end of the fiber, another possibility is to deposit the silicon directly onto a cleaved optical fiber. In this section we describe such a process. Before sputtering it was necessary to find a convenient way to hold the optical fibers into the deposition chamber. To do so we created a fiber holder that consists of 40 thin capillaries attached to a brass holder. Each cleaved fiber can be threaded through the capillaries and then be mounted into the sputtering machine. The target used for the sputtering is a P-Type Silicon (Boron Doped) with a purity of 99.999%, a 2 inches diameter and a ¼ inch thickness. The doping of the silicon should not matter as it should have a negligible effect on the optical properties. The assembly was mounted in a Magnetron sputtering machine and a long deposition was conducted to produce a thick film of silicon on the ends of the optical fiber.

In order to better describe the invention presented herein a set of measurements related to fouling measurements are described that were obtained with a fabricated fabry perot cavity.

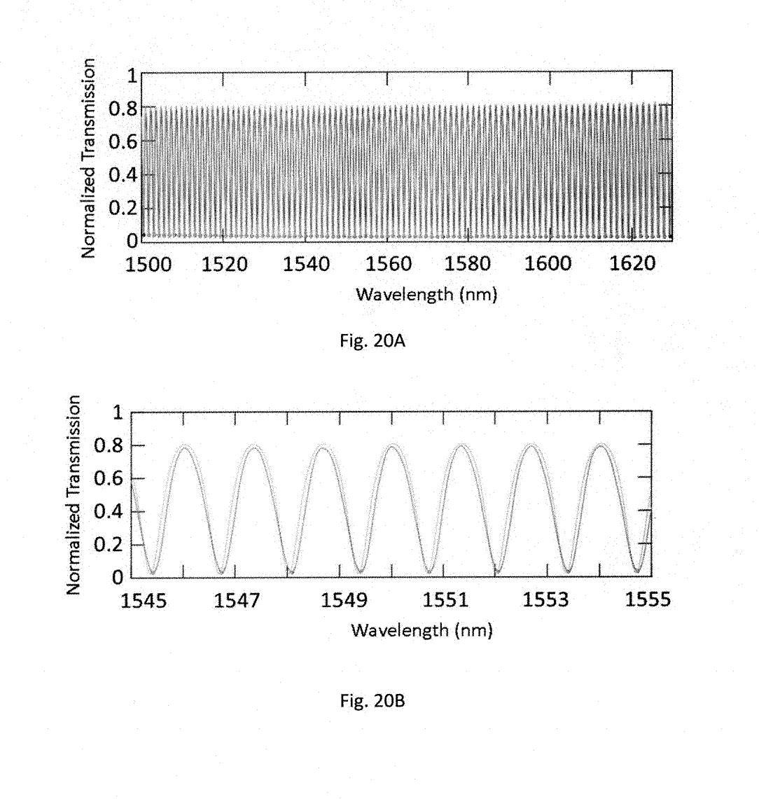

The measurement of the reflected signal is performed in a similar way as described by G Liu et al. But instead of using a white light source and a spectrometer we are using a tunable laser and a single photodiode for measurement. (G. Liu and M. Han, “Fiber-optic gas pressure sensing with a laser-heated silicon-based Fabry-Perot interferometer,” Optics letters, vol. 40, no. 11, pp. 2461-2464, 2015). The setup is represented in FIG. 19. The light emitted by a tunable telecom laser 129 (Santec 1500-1630 nm) is attenuated by a variable optical attenuator. It is sent to the fiber through a circulator 130 and the reflected signal is redirected to a photodiode 131 by the circulator 130. In order to be able to send red light 132 (780 nm) to the silicon in order to heat up the silicon chip, we use a coupler 133. The result of a frequency sweep over the entire frequency range of the laser is shown on FIG. 20. After normalization the signal envelope depends weakly on the wavelength. The value L=259.64 μm of the thickness for the silicon sensor was extracted from the theoretical fit is in reasonable agreement with the value provided by the manufacturer of the silicon wafer.

An initial test was conducted with a 1 mW laser. It was demonstrated that the reflection spectrum from the silicon can be measured with a tunable laser. It was then demonstrated that a red laser could be used to heat up the silicon chip. Indeed at 780 nm the silicon is opaque and should absorb most of the incident light. In order to monitor the power sent to the chip, we use a power-meter positioned on the 10% arm of a 90/10 beamsplitter. The red light intensity is then varied from 0 to around 1 mW by step of 40 μW, while a spectrum is acquired for each value.

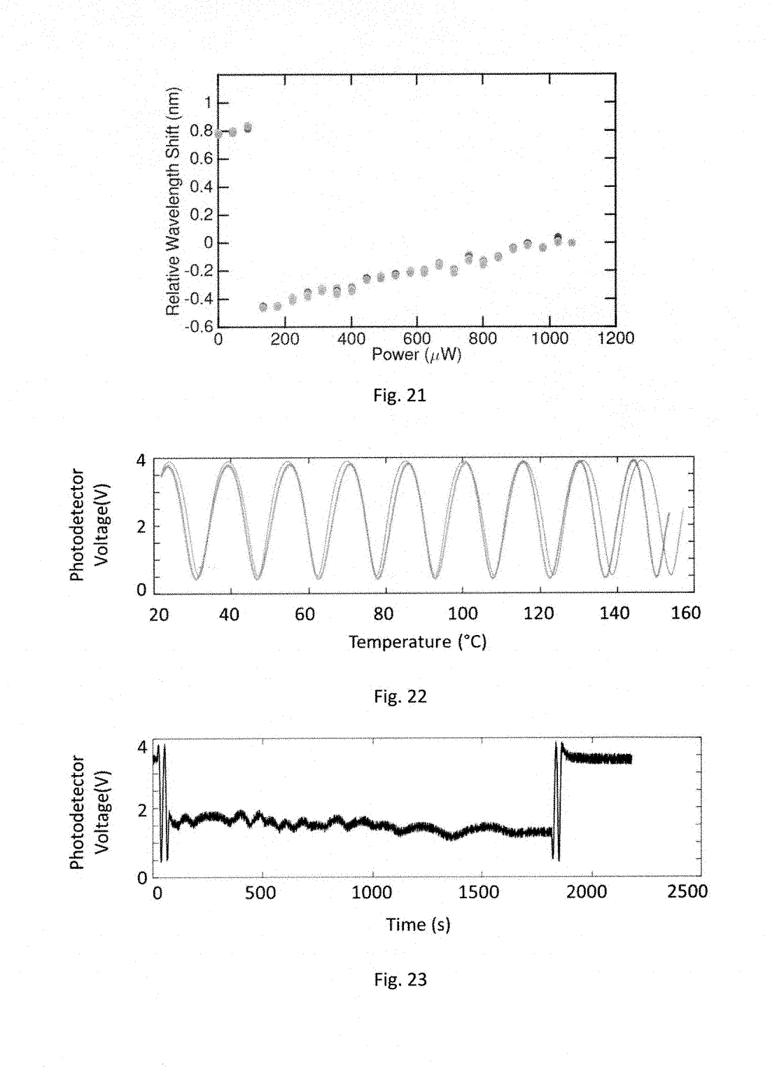

On FIG. 21 we represent the position of the 20th to 30th local minima as a function of incident red intensity. We can observe a linear change of the minimum wavelength likely related to a temperature change of the silicon chip. The slope is about 0.5 nm every 100 μW.

Given the value of λ¹0^{d}d^{λ}T⁰=84.6 pm/° C., we can then translate the value for the slope to 7° C. every 100 μW.

Instead of using an expensive tunable laser, the system can be setup with a cheaper telecom laser. Therefore, the wavelength cannot be swept to probe the contrast of the interference fringes, but instead the temperature of the tip can be increased to change the path length. In other words, to change the phase delay δ=nk2L, one can either change the wavenumber k by changing the wavelength or one can change the value n(T)L(T) by adjusting the temperature, removing the need of an expensive tunable laser.

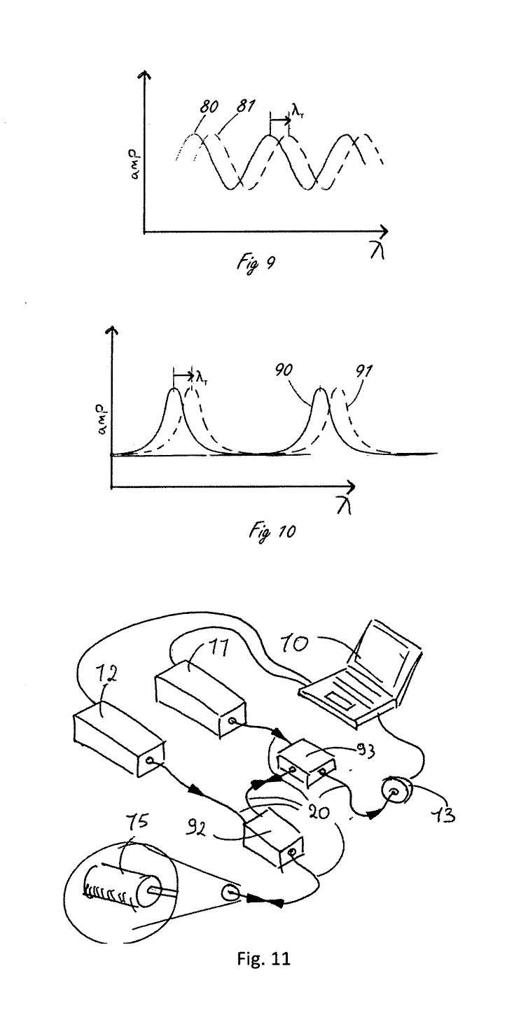

The setup used is shown in FIG. 11 with the difference that the tip is immersed in a oil bath placed on a heated plate. The temperature of the bath is monitored using a thermocouple located less than 5 mm from the tip of the sensor to ensure having a good temperature agreement between the two. The temperature is increased up to 160° C. while the data are acquired during the cool down to avoid the turbulent convection due to the localized heating of the hot plate, causing temperature spikes on the sensor tip. The reflection intensity vs temperature is shown in FIG. 22. After the oil cooled down, we used a 973 nm laser diode to heat up the silicon tip immersed in oil. The power of the laser was increased to maximum power (43 mW coupled to the silicon tip), kept at the maximum intensity for ˜30 min and then reduced down to zero. At the same time the reflected intensity of the probe laser was measured. The reflected intensity is plotted vs time for this experiment showing several fringes pass on heat up and cool down in FIG. 23. Thanks to the previous calibration, the temperature of the tip can be deduced from this measurement. Given the number of free spectral ranges scanned during the laser heating, we can deduce an approximate tip temperature of 26° C.

### REFERENCES CITED

1. B. D. Hauer, P. H. Kim, C. Doolin, A. J. MacDonald, H. Ramp, and J. P. Davis, “On-chip cavity optomechanical coupling,” EPJ Techniques and Instrumentation, vol. 1, p. 4, December 2014.

2. A. J. R. Macdonald, B. D. Hauer, X. Rojas, P. H. Kim, G. G. Popowich, and J. P. Davis, “Optomechanics and thermometry of cryogenic silica microresonators,” Physical Review A—Atomic, Molecular, and Optical Physics, vol. 93, no. 1, pp. 1-9, 2016.

3. G. Liu, M. Han, and W. Hou, “High-resolution and fast-response fiber-optic temperature sensor using silicon Fabry-Perot cavity,”’ Optics Express, vol. 23, no. 6, p. 7237, 2015.

4. G. Liu and M. Han, “Fiber-optic gas pressure sensing with a laser-heated silicon-based Fabry-Perot interferometer,” Optics letters, vol. 40, no. 11, pp. 2461-2464, 2015.

5. C. Doolin, P. Doolin, B. C. Lewis, and J. P. Davis, “Refractometric sensing of Li salt with visible-light Si3N4 microdisk resonators,” Applied Physics Letters, vol. 106, no. 8, 2015.

6. T. Stephenson, M. Hazelton, M. Kupsta, J. Lepore, E. J. Andreassen, A. Hoff, B. Newman, P. Eaton, M. Gray, and D. Mitlin, “Thiophene mitigates high temperature fouling of metal surfaces in oil refining,” Fuel, vol. 139, pp. 411-424, 2015.

### DETAILED DESCRIPTION

FIG. 1 is a schematic view of the optical measurement system. The computer control system 10 is connected to the optical temperature measurement light source 11, the optical heating light source 12, and the optical measurement detector 13. The optical signals are carried to and from the fouling sensor 15 using fiber optic cables 20.

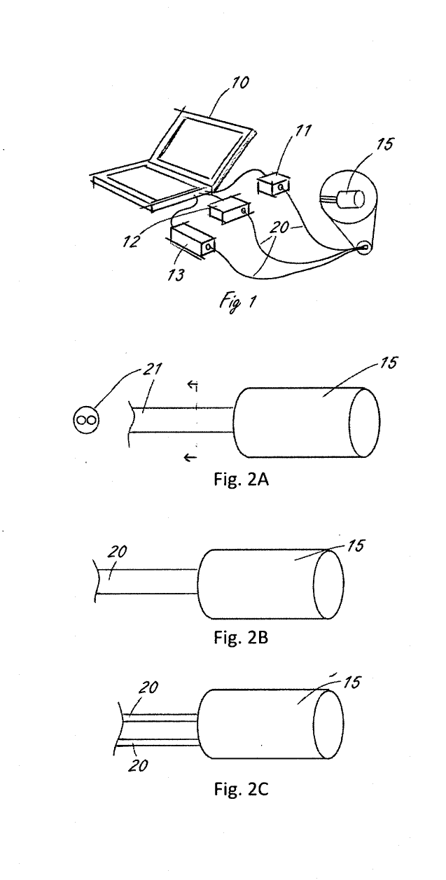

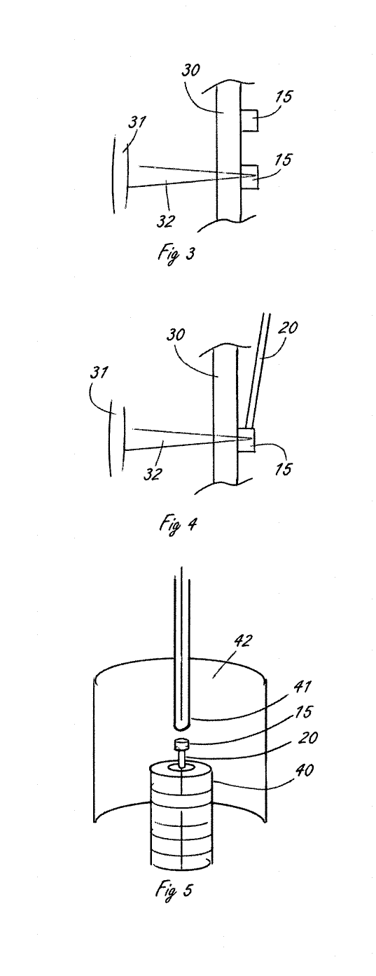

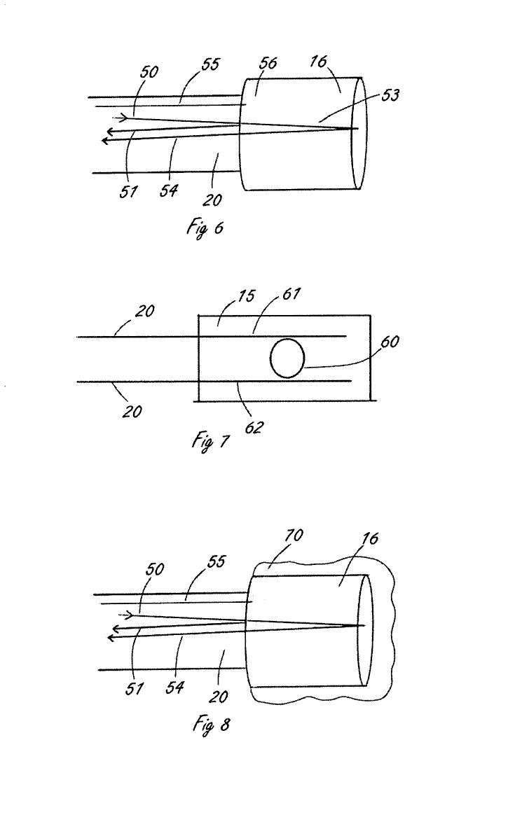

FIG. 2 illustrates possible methods for bringing optical signals to and from the fouling sensor 15. In FIG. 2A a multi-core fiber 21—in this example with two cores—is used to bring the optical signals to the fouling sensor 15. The dotted line shows the cross section of the multi-core fiber 21. Each core may bring a different optical signal to the sensor, such as one core bringing the optical temperature measurement signal, and the other core bringing the optical heating signal. FIG. 2B illustrates a single fiber optic cable 20 bringing the optical signals to the fouling sensor 15. In this example the single fiber may bring both the optical temperature signal to and from the sensor 15, and also the optical heating signal to the sensor 15. In FIG. 2C illustrates two separate fiber optic cables 20 bringing optical signals to and/or from the fouling sensor 15. The individual fiber optic cables 20 may each separately bring the optical temperature sensing signal to/from, and the optical heating signal to, respectively, the fouling sensor 15.

FIG. 3 illustrates the example of using a free space optical source to address the fouling sensor 15. A lens system 31 is used to focus the free space optical signal 32 through an optically transparent window 30 which then interacts with the fouling sensor 15. In the case of the optical temperature signal the signal follows the same free space path in reverse to eventually reach the detector. This example also illustrates multiple fouling sensors 15 in the same testing environment. This method may be used for the optical temperature sensing signal and/or the optical heating signal.

FIG. 4 illustrates the example of using a combined free space optical signal 32 and optical fiber 20 to address the fouling sensor 15. For the free space portion, a lens system 31 may be used to focus the free space optical signal 32 through the optically transparent window 30 to the fouling sensor 15. This fouling sensor 15 is simultaneously addressed by a separate optical fiber 20. As an example the free space system may couple the optical temperature sensor signal to the sensor, and the fiber may bring the optical heating signal to the the sensor, or vice versa.

FIG. 5 illustrates a possible implementation of the foulant sensor 15 addressed with a single fiber optic cable 20 through a piece of ¼″ stainless steel pipe 40. The system may also be operated adjacent to secondary sensors such as a Precision RTD 41 within the same fluid chamber 42.

FIG. 6 illustrates the implementation of a Fabry-Pérot type foulant sensor 16. This is also an example of a possible common-path interferometer system. The optical temperature sensor signal 50 is reflected off the interface of the optical fiber 20 and the Fabry-Pérot sensor 16. The Fabry-Pérot sensor signal 53 travels through this optical cavity and after it leaves the cavity this signal 54 interferes with the initial reflected signal 51.The Fabry-Pérot sensor signal 53 is dependent on the temperature of the sensor 16. This sensor is also shows an example of an optical heating signal 55 being sent to the sensor 16. The heat from the optical signal 56 is dumped into the sensor to increase the sensor's temperature.

FIG. 7 illustrates an example implementation of a ring resonator cavity sensor 17. The optical temperature signal is carried to and from the sensor with an optical fiber 20. The input light signal 61 travels to the optical ring resonator 60 where it acts as a temperature dependent pass through filter. The optical signal is passed through the ring resonator 60 to the sensor output 62.

FIG. 8 illustrates the implementation of a Fabry-Pérot type foulant sensor 16 which has undergone fouling. The foulant 70 is deposited on the outside of the Fabry-Pérot type foulant sensor 16. The optical temperature sensor signal 50 is reflected off the interface of the optical fiber 20 and the Fabry-Pérot sensor 16. The foulant 70 changes the heat transport from the foulant sensor 16. This changes the amount of heat 56 required to keep the temperature of the sensor 16 constant. The Fabry-Pérot sensor signal 53 travels through this optical cavity, which length changes due to the change in temperature of the sensor 16, and after it leaves the cavity this signal 54 interferes with the initial reflected signal 51. This sensor is also shows an example of an optical heating signal 55 being sent to the sensor 16. The heat from the optical signal 56 is dumped into the sensor to increase the sensor's temperature. The heat can be modulated to keep the path length constant in the Fabery-Perot sensor and keep the temperature of the foulant sensor 16 constant during a fouling test.

FIG. 9 illustrates a possible example signal of the readout of an interferometer measurement system. The optical amplitude signal is measured as a function of optical signal wavelength before 80 and after 81 a temperature change. From this change you may calibrate the change in the temperature of the system. To maintain the temperature of the sensor, λₜ should be held at 0.

FIG. 10 illustrates a possible example signal of the readout of an optical cavity measurement system. In this case the optical cavity is acting as a pass through optical filter. The optical amplitude signal is measured as a function of optical signal wavelength before 90 and after 91 a temperature change. From this change you may calibrate the change in the temperature of the system. To maintain the temperature of the sensor, λₜ should be held at 0.

FIG. 11 is a schematic view of another optical measurement system. The computer control system 10 is connected to the optical temperature measurement light source 11, the optical heating light source 12, and the optical measurement detector 13. The optical signals are carried to and from the fouling sensor 15 using fiber optic cables 20. The measurement light propagates from source 11 through the optical circulator 93, which redirects it toward the wavelength division multiplexer 92 to final reach the fouling sensor 15. The light is reflected back and the optical circulator 93 sends it the measurement detector 13. Simultaneously heating light can be sent from source 12 to the sensor 15 using the wavelength division multiplexer 92.

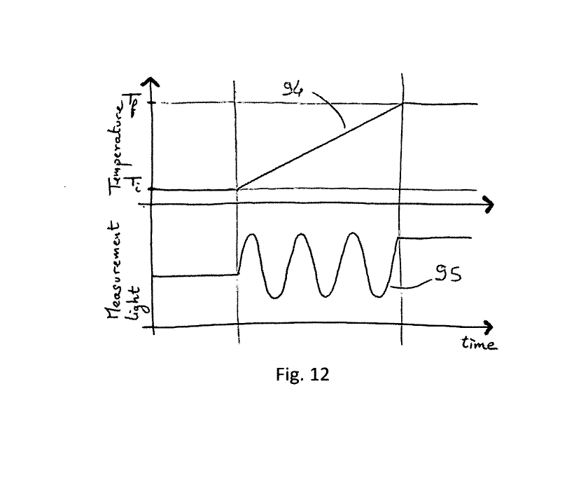

FIG. 12 illustrates a possible measurement performed for initial calibration of the sensor. The sensor is placed in a temperature-regulated bath while recording the measurement light. As the temperature is increased from Ti to Tf (94), the optical interferences in the fouling sensor modulate the detected light (95). Knowing Ti,Tf and the number of fringes scanned, the sensitivity of the sensor can be determined. This waveform can then be fit to an equation and used to extrapolate higher temperatures reached by the fouling sensor when the heating light power is increased. For example if exactly 5 fringes are scanned as the sensor body is heated from 20° C. to 120° C. in a heated bath we would have an approximate temperature per fringe of 20° C. If at the end of the calibration the heating light power was increased so that exactly 1 more fringe is scanned it can be approximated that the temperature of the sensor is now 20° C. above the 120° C. bath temperature. To conduct a fouling experiment with a delta temperature of 20° C. a feedback loop would be used to maintain the intensity of the measurement light or the position of the fringe by adjusting the heating light power. As fouling forms on the sensor surface that reduces the thermal conductivity from the sensor the amount of power required to keep the measurement intensity constant would be reduced. The feedback loop is complicated by the requirement that the position on the fringe waveform affects the response of the system to added heat. If the position is on the positive slope section of the fringe then adding heat causes an increase of the intensity of the fringe. If the position is on the negative slope section of the fringe than adding heat causes a decrease in the intensity of the fringe. Therefore it is important to gradually increase and decrease the heating light power and always keep track of the present position on the fringe waveform obtained by the calibration.

This waveform in FIG. 12 can be fit to the theoretical prediction of the reflected intensity, based on a model of an asymmetric Fabry-Pérot resonator. The reflected intensity is given by:

$${I}_{r} = {E}_{0}^{2} \frac{{r}_{1}^{2} + {r}_{2}^{2} - 2 {r}_{1} {r}_{2} cos ( δ ( T ) )}{{( 1 - {r}_{1} {r}_{2} )}^{2} + 4 {r}_{1} {r}_{2} {sin}^{2} ( δ ( T ) / 2 )}$$

Where E₀² is the incident intensity,r₁ is the reflection coefficient at the glass-silicon interface, r₂ is the reflection coefficient at the silicon-oil interface, and δ(T) is the phase accumulated after a round-trip through the silicon cavity. δ(T) can be expressed as δ(T)=n(T)k2L(T) where the refractive index n and the length L of the cavity carry the temperature dependence, while k is the wavenumber of the incident light. This equation for the reflected light intensity can be used to extrapolate the temperature given the reflected intensity.

FIG. 13 is a diagram of the pressure sensor designed by Liu et al. (G. Liu and M. Han, “Fiber-optic gas pressure sensing with a laser-heated silicon-based Fabry-Perot interferometer,” Optics letters, vol. 40, no. 11, pp. 2461-2464, 2015.) The silicon pillar 96 can be heated using visible light, while its length can be probed using telecom wavelength light. The silicon pillar 96 is attached to the end of a commercial optical fiber 97, allowing for an all-optical probe that can be remotely measured. The optical resonances at telecom wavelengths in the pillar 99 and 100 are sensitive to the length of the pillar 101, and therefore its temperature. In the present invention, monitoring the probe temperature and comparing it to the surrounding heavy-oil environment for a known power input, allows for decreased thermal conductivity due to foulant buildup to be quantified.

FIG. 14 is a diagram showing the reelections of light that result in the Fabry-Perot resonator descried in this work. The incoming light 102 is both reflected 103, 104, and 105 described as Eᵣ_{₁}, Eᵣ_{₂} and Eᵣ_{₃} in equation [0083] and transmitted 106 and 107 described as Eₜ_{₁} and Eₜ_{₂}in equation [0078] at the two interfaces of the sensor 108 and 109.

What is claimed is:

1) A method of conducting a fouling test, comprising:
using an optical source to measure the temperature of the sensor;
using an optical source to control the heating of the sensor;
determining the amount of foulant accumulation on the optical sensor probe using a heat transfer measurement to determine a fouling factor.

2) The method of claim 1, wherein an optical fiber is used to carry the optical signal to the sensor used to detect the temperature of the probe.

3) The method of claim 1, wherein an optical fiber is used to carry the heating optical signal to the probe.

4) The method of claim 1, wherein a free-space optical source passed through an optically transparent window to transmit the optical signal to and/or from the optical temperature probe.

5) The method of claim 1, wherein a free-space optical source passed through an optically transparent window is used to control the sensor heating.

6) The method of claim 1, further comprising:
using a single optical fiber to access the optical probe, wherein the optical signal to detect the temperature and the optical signal to control the sensor heating are both carried on that fiber.

7) The method of claim 1, further comprising:
using multiple optical fibers to access the optical probe, wherein the optical signal to detect the temperature and the optical signal to control the sensor heating are carried on independent fibers.

8) The method of claim 1, wherein the fouling measurement system uses any combination of claims 2-5.

9) The method of claim 8, wherein one or more optical test sensors are independently controlled to perform either simultaneous or sequential fouling tests.

10) The method of claim 1, wherein an optical cavity is used to determine the sensor temperature.

11) The method of claim 1, wherein an interferometric method is used to determine the sensor temperature.

12) The method of claim 1, wherein a fluorescent material is used to determine the sensor temperature.

13) The method of claim 10, wherein a Fabry-Perot type optical cavity is used.

14) The method of claim 10, wherein a ring resonator type optical cavity is used.

15) The method of claim 10, wherein a racetrack resonator type optical cavity is used.

16) The method of claim 10, wherein a photonic crystal type optical cavity is used.

17) The method of claim 11, wherein a common path interferometer is used.

18) The method of claim 11, wherein a double path interferometer is used.

19) The method of claim 12, wherein the fluorescent signal magnitude is used to determine the sensor temperature.

20) The method of claim 12, wherein the fluorescent signal decay is used to determine the sensor temperature.

21) The method of claim 10, wherein the shift of the optical wavelength of the signal is used to quantify the temperature of the sensor.

22) The method of claim 11, wherein the shift of the optical wavelength of the signal is used to quantify the temperature of the sensor.

23) The method of claim 1, wherein the optical measurement of the sensor temperature is at a wavelength between 400 nm and 1700 nm.

24) The method of claim 1, wherein the optical heating signal is at a wavelength between 150 nm and 1100 nm.

25) The method of claim 23, wherein a broad spectrum light source is used.

26) The method of claim 23, wherein a laser diode light source is used.

27) The method of claim 26, wherein the laser diode source's wavelength is scanned and the signal is detected as a function of wavelength.

28) The method of claim 26, wherein the temperature of the sensor is swept over a range and the signal is detected as a function of temperature allowing a curve fit calibration.

29) The method of claim 1, wherein the optical detector for the temperature measurement is a spectrometer.

30) The method of claim 1, wherein the optical detector for the temperature measurement is a photodiode.
